(19) United States
(12) Patent Application Publication
(10) Pub. No.: US 2014/0319848 A1
(43) Pub. Date: Oct. 30, 2014

(54) LATCH ASSEMBLY RELEASE EFFORT CONTROL, AND METHOD THEREOF

(71) Applicant: GM GLOBAL TECHNOLOGY OPERATIONS LLC, DETROIT, MI (US)

(72) Inventor: Joseph P. Fannon, Washington, MI (US)

(73) Assignee: GM GLOBAL TECHNOLOGY OPERATIONS LLC, DETROIT, MI (US)

(21) Appl. No.: 14/087,249

(22) Filed: Nov. 22, 2013

Related U.S. Application Data
(60) Provisional application No. 61/817,292, filed on Apr. 29, 2013.

(51) Int. Cl. E05B 83/24

(52) U.S. Cl. CPC E05B 83/243
USPC 292/122

(57) ABSTRACT

A latch assembly for a lid covering a compartment includes a forkbolt, a detent, a forkbolt spring, and a detent spring. The lid is movable between a primary latched position, a secondary latched position, and an open position. The forkbolt and the detent are configured to releasably engage with each other in the primary latched position and the secondary latched position. The forkbolt spring and the detent spring are operatively attached to the forkbolt and the detent, respectively, and are configured to bias the forkbolt and the detent in opposite rotational directions. The forkbolt and the detent are releasable from the primary latched position and the secondary latched position via a first linear force and a second linear force, respectively, applied on the detent. The second linear force is within a predetermined tolerance of the first linear force.

### CROSS REFERENCE TO RELATED APPLICATIONS

This application claims the benefit of U.S. Provisional Application No. 61/817,292, filed Apr. 29, 2013, which is hereby incorporated by reference in its entirety.

### TECHNICAL FIELD

The present invention relates to a latch assembly for a lid covering a compartment, and a method thereof.

### BACKGROUND

Most vehicles include a lid to provide closure to a compartment of the vehicle, such as a hood covering an engine compartment and/or a trunk lid covering a trunk compartment. The lid can be moved between an open position to permit access to the compartment and a latched position against the vehicle body to close off access to the compartment. Generally, a latch assembly retains the lid in the latched position, and may be released to permit the lid to be moved to the open position.

One common type of latch assembly includes a primary latch for latching the hood in a primary latched position, a cable release operable from inside the vehicle to release the primary latch, and a pop-up spring to move the hood to a secondary latched position where the hood is held by a secondary latch. The secondary latch is typically manually operated through access at the front of the vehicle to allow the hood to be unlatched from the secondary position and moved toward the open position.

### SUMMARY

A latch assembly for a lid covering a compartment is provided. The lid is movable between a primary latched position, a secondary latched position, and an open position. The latch assembly includes a forkbolt and a detent configured to engage with each other in at least one of the primary latched position and the secondary latched position. The forkbolt and the detent are releaseable from the primary latched position and the secondary latched position via a first linear force and a second linear force, respectively, applied on the detent. The second linear force is within a predetermined tolerance of the first linear force.

The latch assembly also includes a forkbolt spring and a detent spring. The forkbolt spring is operatively attached to the forkbolt, and is configured to bias the forkbolt in a first rotational direction. The latch assembly further includes a detent spring operatively attached to the detent, the detent spring being configured to bias the detent in a second rotational direction opposite of the first rotational direction to enable the forkbolt and the detent to be engageable in at least one of the primary latched position and the secondary latched position.

A vehicle is also provided. The vehicle includes a plurality of walls defining a compartment, a lid covering the compartment, and the latch assembly described above. As explained above, the lid is movable between a closed position, a semi-released position, and an open position.

A method of moving a lid from a closed position to an open position via the latch assembly described above and a release mechanism is further provided. The release mechanism is attached to the detent of the latch assembly. The method includes applying, by the release mechanism, a first linear force to the detent to release the forkbolt and the detent from the primary latched position into the secondary latched position such that the lid moves from the primary latched position to the secondary latched position. The method then includes applying, by the release mechanism, a second linear force to the detent to release the forkbolt and the detent from the secondary latched position such that the lid moves from the secondary latched position to the open position. The second linear force is within a predetermined tolerance of the first linear force.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, side view of a vehicle having a lid covering a compartment, where the lid is moved between a primary latched position, a secondary latched position, and an open position by a latch assembly;

FIGS. 2A, 2B, and 2C are schematic, side views of the latch assembly of FIG. 1 in the primary latched position, the secondary latched position, and the open position, respectively, according to one embodiment of the present invention;

FIGS. 3A and 3B are schematic, side views of the latch assembly of FIG. 1 in the primary latched position and the open position, respectively, according to another embodiment of the present invention; and

FIG. 4 is a schematic, flow diagram illustrating an exemplary method of operating the latch assembly of FIGS. 2A-2C.

### DETAILED DESCRIPTION

Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

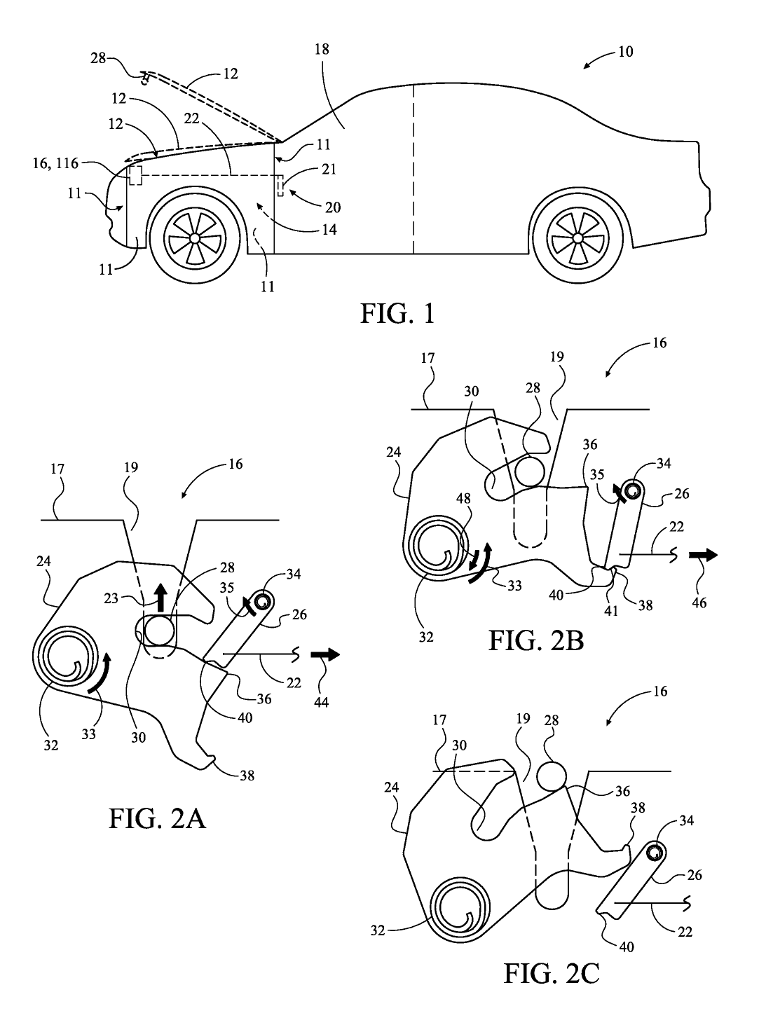

Referring to the drawings, wherein like reference numbers correspond to like or similar components wherever possible throughout the several figures, a vehicle 10 is shown in FIG. 1. The vehicle 10 has a plurality of walls 11 defining a compartment 14, and a lid 12 covering the compartment 14. The lid 12 may be in one of a primary latched position, a secondary latched position, and an open position. The open position generally is any position in which the lid 12 is fully released such that the compartment 14 is accessible. The lid 12 may have a striker bar 28 rigidly attached to it. The vehicle 10 also may have seals (not shown) along at least a portion of the compartment 14 and/or bumpers (not shown) located within the compartment 14 that engage with the lid 12 in the primary latched position in which the seals and/or the bumpers are compressed. This creates an upward force acting on the lid 12, and therefore on the striker bar 28 (as represented by the arrow 23 in FIG. 2A).

The lid 12 is maintained in the primary latched position and the secondary latched position by a latch assembly 16, 116. The latch assembly 16, 116 may be released by a release mechanism 20 to which the latch assembly 16, 116 is attached. The release mechanism 20 may include a lever 21 attached to the latch assembly 16, 116 via a cable 22 or similar mechanism. The release of the latch assembly 16, 116 enables the lid 12 to be moved from the primary latched position to the secondary latched position, from the secondary latched position to the open position, and/or from the primary latched position to the open position. The lever 21 may be located within a passenger compartment 18 of the vehicle 10 where it may be operated by an occupant of the vehicle 10. It should be appreciated that any device configured to activate the release mechanism 20, including, but not limited to, a button, may be used in lieu of the lever 21. It should further be appreciated that the latch assembly 16, 116 may be released electronically, in which embodiment the lever 21 (or other release activation device) may be connected to the latch assembly 16 via electrical wires or the like.

While the latch assembly 16, 116 is shown in FIG. 1 as being used with a hood covering an engine compartment of a vehicle, it should be appreciated that the latch assembly 16, 116 may be utilized with any lid covering any compartment, including, but not limited to, a trunk lid for a trunk of a vehicle.

Referring now to FIGS. 2A-2C, the latch assembly 16 generally includes a latch frame 17, a forkbolt 24, and a detent 26. The latch frame 17 may define a fishmouth slot 19 in which the striker bolt 28 is slidable when the lid 12 is moving between positions. The forkbolt 24 and the detent 26 are configured to engage with each other such that they releasably retain the lid 12 in the primary latched position, as seen in FIG. 2A, and/or the secondary latched position, as seen in FIG. 2B. When the occupant of the vehicle 10 operates the latch assembly 16 to move the lid 12 from the secondary latched position to the open position such that the forkbolt 24 and the detent 26 are disengaged from each other, as seen in FIG. 2C, the latch assembly 16 may provide feedback to the occupant. The feedback may be, but is not limited to, tactile feedback, as described below, audio feedback, and the like.

The forkbolt 24 may also be configured to engage with the striker bar 28 to hold the lid 12 in the primary latched position and/or the secondary latched position. The forkbolt 24 may define a forkbolt slot 30 in which the striker bar 28 is also slidable. When the lid 12 is in the primary latched position, the striker bar 28 exerts upon the forkbolt 24 the upward force 23 resulting from the compressed seals and/or bumpers described above. As the forkbolt 24 rotates, the slot 30 guides the striker bar 28 to move vertically in the fishmouth slot 19 such that the lid 12 may be moved between the different positions.

The forkbolt 24 is operatively attached to a forkbolt spring 32. The forkbolt spring 32 is configured to bias the forkbolt 24 (a counterclockwise bias 33 in FIGS. 2A and 2B) to a released position (as seen in FIG. 2C). The forkbolt spring bias 33 has an upward force component that acts on the forkbolt 24 in conjunction with the upward force 23. Similarly, the detent 26 is operatively attached to a detent spring 34. The detent spring 34 is configured to bias the detent 26 in an opposite rotational direction as the forkbolt spring 32 (a clockwise bias 35 in FIGS. 2A and 2B) to a latched position (as seen in FIG. 2C). The detent spring bias 35 has a lateral force component. The opposite directions of the biases 33 and 35 allow the forkbolt 24 and the detent 26 to lock together, as explained in more detail below. The forkbolt spring 32 and the detent spring 34 may be, but are not limited to, torsion springs. It should be appreciated that any other mechanism configured to bias the forkbolt 24 to its released position and the detent 26 to its latched position may be utilized in the latch assembly 16.

The forkbolt 24 may include a first forkbolt bite tooth 36 and a second forkbolt bite tooth 38, and the detent 26 may include a detent bite tooth 40. The first forkbolt bite tooth 36 is configured to engage with the detent bite tooth 40 to hold the forkbolt 24 and the detent 26 together in the primary latched position, as seen in FIG. 2A. In the primary latched position, the forkbolt slot 30 is oriented such that the striker bar 28 is at its lowest vertical position within the fishmouth slot 19, and is restricted from moving vertically.

The bias of the forkbolt spring 32 combined with the upward force 23 generate a frictional force between the first forkbolt bite tooth 36 and the detent bite tooth 40 that generally inhibits movement of the detent 26. The magnitude of the frictional force may be dependent upon various factors including, but not limited to, the output of the forkbolt spring 32, the geometry and dimensions of the forkbolt 24 and the detent 26, their positions relative to each other, and the magnitude of the upward force 23.

The second forkbolt bite tooth 38 is configured to engage with the detent bite tooth 40 to hold the forkbolt 24 and the detent 26 together in the secondary latched position, as seen in FIG. 2B. In the secondary latched position, the forkbolt slot 30 is oriented such that the striker bar 28 is in an intermediate vertical position within the fishmouth slot 19. Unlike in the primary latched position, the seals and/or bumpers may no longer be compressed, and as such, there may be little to no upward force 23. Consequently, the second forkbolt bite tooth 38 and the detent bite tooth 40 are locked together only by a frictional force between them generated from the forkbolt spring bias 33 and the detent spring bias 35.

To release the forkbolt 24 and the detent 26 from the primary latched position to the secondary latched position, the frictional force between the first forkbolt bite tooth 36 and the detent bite tooth 40, as well as the lateral force component of the detent spring bias 35, must be overcome such that the forkbolt bite tooth 36 and the detent bite tooth 40 become disengaged from each other. The slot 30 then may guide the striker bar 28 to move vertically to the intermediate vertical position. This is accomplished by applying a first linear force 44 on the detent 26, which may be done by pulling the lever 21 in the passenger compartment 18, as explained above. As a result, a tension is applied to the cable 22, and therefore to the detent 26. Subsequently, the forkbolt spring 32 moves the forkbolt 24 toward its released position until the detent bite tooth 40 and the second forkbolt bite tooth 38 engage with each other to lock the forkbolt 24 and the detent 26 in the secondary latched position.

To release the forkbolt 24 and the detent 26 from the secondary latched position, thereby removing the vertical movement restriction on the striker bar 28, the frictional force between the second forkbolt bite tooth 38 and the detent bite tooth 40, as well as the lateral force component of the detent spring bias 35, must be overcome such that the second forkbolt bite tooth 38 and the detent bite tooth 40 become disengaged from each other. This is accomplished by applying a second linear force 46 on the detent 26, which again may be applied via the lever 21 and the cable 22, as explained above.

As the second linear force 46 is being applied to disengage the detent bite tooth 40 from the second forkbolt bite tooth 38, the detent bite tooth 40 follows a contact path 41 along the second forkbolt bite tooth 38. The second forkbolt bite tooth 38 and/or the detent bite tooth 40, and therefore the contact path 41, may be inclined such that, as the detent bite tooth 40 travels along the contact path 41, the forkbolt 24 rotates in a rotational direction (a clockwise rotation as indicated by the arrow 48 in FIG. 2B) opposite to that of the forkbolt spring bias 33. This increases the frictional force between the second forkbolt bite tooth 38 and the detent bite tooth 40, thereby increasing the second linear force 46 required to disengage them from each other. The increase in the second linear force 46 provides the occupant of the vehicle 10 with a tactile feedback when he operates the lever 21 to release the lid 12 from the secondary latched position via the release mechanism 20. This allows the occupant to know that this action is in fact releasing the latch to the open position.

The contact path 41 may be curved such that the incline increases along the contact path 41, or may be angled such that the incline is steady. The second linear force 46 generally increases as the incline of the contact path 41 increases. As such, the shape of the contact path 41 may be calibrated such that the magnitude and profile of the second linear force 46 may be within a predetermined tolerance of the first linear force 44 despite the absence of the upward force 23.

After the forkbolt 24 and the detent 26 are released from the secondary latched position, the forkbolt 24 guides the striker bar 28, via the forkbolt slot 30, vertically along the fishmouth slot 19, thereby moving the lid 12 into the open position.

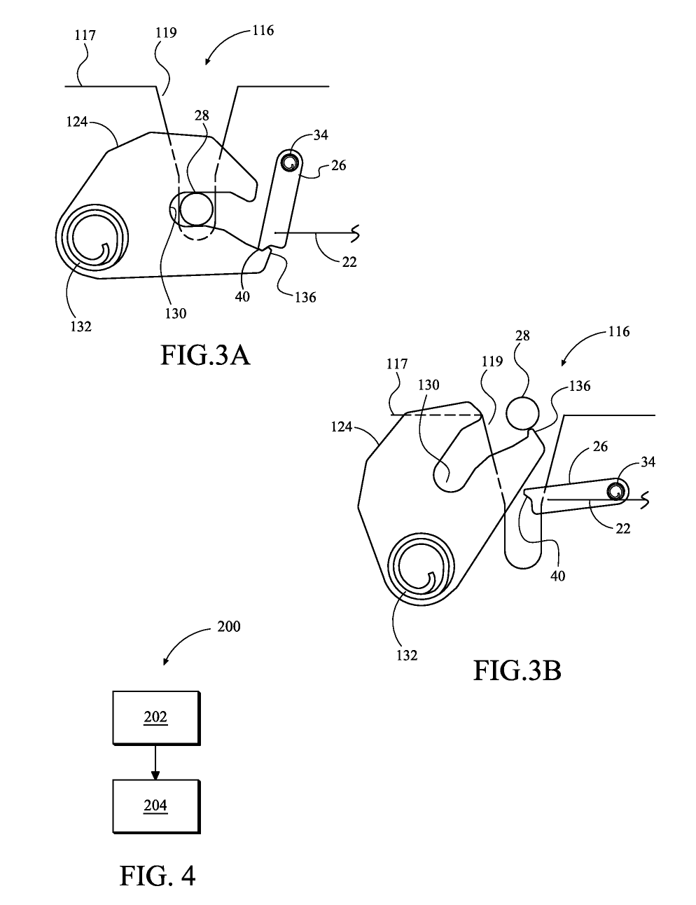

Referring now to FIGS. 3A and 3B, a latch assembly 116 according to another embodiment of the present invention is shown. The latch assembly 116 includes a latch frame 117, forkbolt 124, and the detent 26. The latch frame 117 defines a fishmouth slot 119 in which the striker bar 28 is slidable. The forkbolt 124 includes only a first forkbolt bite tooth 136. The first forkbolt bite tooth 136 is shaped similar to the second forkbolt bite tooth 38 in the embodiment of FIGS. 2A-2C, and interacts with the detent bite tooth 40 in a similar manner. The forkbolt 124 and the detent 26 move from the primary latched position, as seen in FIG. 3A, to the open position, as seen in FIG. 3B. The forkbolt 124 also includes a forkbolt spring 132 that operates in the same manner as described above. The forkbolt 124 further may define a forkbolt slot 130 that interacts with the striker bar 28 to maintain the lid 12 in the primary latched position.

Referring now to FIG. 4, a method 200 for moving the lid 12 from the primary latched position to the open position via the latch assembly 16 and the release mechanism 20 is provided. As explained above, the latch assembly 16 provides tactile feedback to the user that the lid 12 has been transitioned into the open position. Prior to the start of method 200, the lid 12 and the latch assembly 16 are in the primary latched position, as described above and seen in FIG. 2A.

Method 200 begins at step 202 in which a first linear force 44 is applied to the detent 26 via the release mechanism 20 such that the detent bite tooth 40 disengages from the first forkbolt bite tooth 36. As a result, the lid 12 and the latch assembly 16 transition into the secondary latched position. As explained above, in the secondary latched position, the detent bite tooth 40 engages with the second forkbolt bite tooth 38 to retain the forkbolt 24 and the detent 26 in the secondary latched position.

After step 202, method 200 then proceeds to step 204. At step 204, a second linear force 46 is applied to the detent 26 via the release mechanism 20 such that the detent bite tooth 40 disengages from the second forkbolt bite tooth 38 and the forkbolt 24 and the detent 26 are released from the secondary latched position. As explained above, the contact path 41 between the second forkbolt bite tooth 38 and the detent bite tooth 40 is inclined, thereby requiring the second linear force 46 to be of a magnitude that provides the user with a tactile feedback that the lid 12 has been released into the open position. After the forkbolt 24 and the detent 26 are released from the secondary latched position, the lid 12 is moved into the open position. Method 200 ends after step 204.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A latch assembly for a lid covering a compartment, the lid being movable between a primary latched position, a secondary latched position, and an open position, the latch assembly comprising:
a forkbolt and a detent configured to releasably engage with each other in at least one of the primary latched position and the secondary latched position;
a forkbolt spring operatively attached to the forkbolt, the forkbolt spring being configured to bias the forkbolt in a first rotational direction; and
a detent spring operatively attached to the detent, the detent spring being configured to bias the detent in a second rotational direction opposite of the first rotational direction to enable the forkbolt and the detent to be engageable in at least one of the primary latched position and the secondary latched position;
wherein the forkbolt and the detent are releasable from the primary latched position and the secondary latched position via a first linear force and a second linear force, respectively, applied on the detent; and
wherein the the second linear force is within a predetermined tolerance of the first linear force.

2. The latch assembly of claim 1 wherein the forkbolt and the detent comprise a first forkbolt bite tooth and a detent bite tooth, respectively, configured to engage with each other such that the forkbolt and the detent are maintainable in and releasable from the primary latched position.

3. The latch assembly of claim 2 wherein the forkbolt further comprises a second forkbolt bite tooth configured to engage with the detent bite tooth such that the forkbolt and the detent are maintainable in and releasable from the secondary latched position, the forkbolt bite tooth and the detent bite tooth forming a contact path along which the detent bite tooth moves when the forkbolt and the detent are being released from the secondary latched position, the contact path being inclined such that the second linear force is within the tolerance of the first linear force.

4. The latch assembly of claim 3 wherein the contact path is curved.

5. The latch assembly of claim 3 wherein the contact path is angled.

6. A vehicle comprising:
a plurality of walls defining a compartment;
a lid configured to cover the compartment, the lid being movable between a primary latched position, a secondary latched position, and an open position; and
a latch assembly having:
a forkbolt and a detent configured to releasably engage with each other in at least one of the primary latched position and the secondary latched position;
a forkbolt spring operatively attached to the forkbolt, the forkbolt spring being configured to bias the forkbolt in a first rotational direction; and
a detent spring operatively attached to the detent, the detent spring being configured to bias the detent in a second rotational direction opposite of the first rotational direction to enable the forkbolt and the detent to be engageable in at least one of the primary latched position and the secondary latched position;
wherein the forkbolt and the detent are releasable from the primary latched position and the secondary latched position via a first linear force and a second linear force, respectively, applied on the detent; and
wherein the second linear force is within a predetermined tolerance of the first linear force.

7. The vehicle of claim 6 wherein the forkbolt and the detent of the latch assembly comprise a first forkbolt bite tooth and a detent bite tooth, respectively, configured to engage with each other such that the forkbolt and the detent are maintainable in and releasable from the primary latched position.

8. The vehicle of claim 7 wherein the forkbolt further comprises a second forkbolt bite tooth configured to engage with the detent bite tooth such that the forkbolt and the detent are maintainable in and releasable from the secondary latched position, the forkbolt bite tooth and the detent bite tooth forming a contact path along which the detent bite tooth moves when the forkbolt and the detent are being released from the secondary latched position, the contact path being inclined such that the second linear force is within the tolerance of the first linear force.

9. The vehicle of claim 8 wherein the contact path is curved.

10. The vehicle of claim 8 wherein the contact path is angled.

11. The vehicle of claim 6 wherein the lid comprises a striker bar, and the forkbolt comprises a slot in which the striker bar is slidable, the slot being configured to guide the striker bar to move vertically to move the lid between the primary latched position, the secondary latched position, and the open position.

12. The vehicle of claim 6 further comprising a release mechanism connected to the detent of the latch assembly, the release mechanism being configured to apply the first linear force and the second linear force.

13. A method for moving a lid of a vehicle from a primary latched position to an open position via a latch assembly and a release mechanism, the latch assembly having a forkbolt and a detent engageable in the primary latched position and a secondary latched position, the release mechanism being attached to the detent, the method comprising:
applying, by the release mechanism, a first linear force to the detent to release the forkbolt and the detent from the primary latched position into the secondary latched position such that the lid moves from the primary latched position to the secondary latched position; and
applying, by the release mechanism, a second linear force to the detent to release the forkbolt and the detent from the secondary latched position such that the lid moves from the secondary latched position to the open position;
wherein the second linear force is within a predetermined tolerance of the first linear force.
